(19) United States
(12) Patent Application Publication
(10) Pub. No.: US 2026/0267502 A1
(43) Pub. Date: Sep. 10, 2026

(54) INFORMATION PROCESSING SYSTEM, CONTROL METHOD, STORAGE MEDIUM, INFORMATION PROCESSING DEVICE, AND TERMINAL DEVICE

(71) Applicant: HONDA MOTOR CO., LTD., Tokyo (JP)

(72) Inventors: Kohei TAKIZAWA, Saitama (JP); Andrii PYDIN, Saitama (JP); Minoru MAEDAKO, Saitama (JP)

(73) Assignee: HONDA MOTOR CO., LTD., Tokyo (JP)

(21) Appl. No.: 19/533,324

(22) Filed: Feb. 9, 2026

(30) Foreign Application Priority Data
Mar. 10, 2025 (JP) 2025-037309

(51) Int. Cl. G06F 3/04883; G06F 1/26; G06F 1/3203; G06F 3/0482

(52) U.S. Cl. CPC G06F 3/04883; G06F 1/266; G06F 1/3203; G06F 3/0482

(57) ABSTRACT

An information processing system includes: an information processing device; a terminal device communicably connected to the information processing device and including a display unit; a first device including a first power storage unit; and a second device including a second power storage unit and configured to supply power stored in the second power storage unit to the first device. The terminal device is configured to display, on the display unit, a determination result of whether a suppliable power amount from the second device satisfies a power demand amount from the first device, based on information received from the information processing device.

### CROSS-REFERENCE TO RELATED APPLICATIONS

This application is based on and claims priority under 35 USC 119 from Japanese Patent Application No. 2025-037309 filed on Mar. 10, 2025, the contents of which are incorporated herein by reference.

### TECHNICAL FIELD

The present disclosure relates to an information processing system, a control method, a storage medium, an information processing device, and a terminal device.

### BACKGROUND

Japanese Patent Application Laid-Open Publication No. 2024-049462A discloses a technique in which a display screen on which a graphic indicating a deliverer location, a graphic indicating a user location, and a graphic indicating a remaining capacity of a mobile battery carried by a deliverer are arranged on a map is displayed on a display unit of a user terminal that has received deliverer information.

However, in the related art, it is difficult for a user to easily ascertain whether a suppliable power amount from a device on a power feeding side (that is, a side that feeds power) satisfies a power demand amount from a device on a power receiving side (that is, a side that receives power), and thus there is room for improvement from the viewpoint of improving convenience of the user.

The present disclosure provides an information processing system, a control method, a storage medium, an information processing device, and a terminal device that can display a display screen that allows a user to easily ascertain whether a suppliable power amount from a device on a power feeding side satisfies a power demand amount from a device on a power receiving side and improve convenience of the user.

### SUMMARY

A first aspect of the present disclosure relates to an information processing system including: an information processing device; a terminal device communicably connected to the information processing device and including a display unit; a first device including a first power storage unit; and a second device including a second power storage unit and configured to supply power stored in the second power storage unit to the first device. The terminal device is configured to display, on the display unit, a determination result of whether a suppliable power amount from the second device satisfies a power demand amount from the first device, based on information received from the information processing device.

A second aspect of the present disclosure relates to a control method in an information processing system. The information processing system includes: an information processing device; a terminal device communicably connected to the information processing device and including a display unit; a first device including a first power storage unit; and a second device including a second power storage unit and configured to supply power stored in the second power storage unit to the first device. The control method includes displaying, by the terminal device, a determination result of whether a suppliable power amount from the second device satisfies a power demand amount from the first device on the display unit, based on information received from the information processing device.

A third aspect of the present disclosure relates to a non-transitory computer-readable storage medium storing a control program in an information processing system. The information processing system includes: an information processing device; a terminal device communicably connected to the information processing device and including a display unit; a first device including a first power storage unit; and a second device including a second power storage unit and configured to supply power stored in the second power storage unit to the first device. The control program causes the terminal device to perform a process including displaying, on the display unit, a determination result of whether a suppliable power amount from the second device satisfies a power demand amount from the first device, based on information received from the information processing device.

A fourth aspect of the present disclosure relates to an information processing device in an information processing system. The information processing system includes: the information processing device; a terminal device communicably connected to the information processing device and including a display unit; a first device including a first power storage unit; and a second device including a second power storage unit and configured to supply power stored in the second power storage unit to the first device. The information processing device is configured to transmit, to the terminal device, information for causing the display unit to display a determination result of whether a suppliable power amount from the second device satisfies a power demand amount from the first device.

According to the present disclosure, it is possible to provide an information processing system, a control method, a storage medium, an information processing device, and a terminal device that can display a display screen that allows a user to easily ascertain whether a suppliable power amount from a device on a power feeding side satisfies a power demand amount from a device on a power receiving side and improve convenience of the user.

### BRIEF DESCRIPTION OF DRAWINGS

Exemplary embodiment(s) of the present disclosure will be described in detail based on the following figures, wherein

FIG. 1 illustrates an information processing system 5 according to an embodiment of the present disclosure;

FIG. 2 illustrates an example of a power feeder information table 101;

FIG. 3 is a diagram (part 1) illustrating an example of a display screen DS displayed on a display unit 181 by a user terminal 180;

FIG. 4 is a diagram (part 2) illustrating an example of the display screen DS displayed on the display unit 181 by the user terminal 180;

FIG. 5 is a diagram (part 3) illustrating an example of the display screen DS displayed on the display unit 181 by the user terminal 180;

FIG. 6 is a diagram (part 4) illustrating an example of the display screen DS displayed on the display unit 181 by the user terminal 180;

FIG. 7 is a diagram (part 5) illustrating an example of the display screen DS displayed on the display unit 181 by the user terminal 180;

FIG. 8 is a diagram (part 6) illustrating an example of the display screen DS displayed on the display unit 181 by the user terminal 180;

FIG. 9 is a diagram (part 7) illustrating an example of the display screen DS displayed on the display unit 181 by the user terminal 180;

FIG. 10 is a diagram (part 8) illustrating an example of the display screen DS displayed on the display unit 181 by the user terminal 180;

FIG. 11 is a flowchart illustrating an example of first display processing;

FIG. 12 is a flowchart illustrating an example of second display processing; and

FIG. 13 is a flowchart illustrating an example of third display processing.

### DESCRIPTION OF EMBODIMENTS

Hereinafter, an embodiment of an information processing system, a control method, a control program, and a storage medium according to the present disclosure will be described in detail with reference to the drawings.

The following embodiment does not limit the present disclosure, and not all of elements described in the following embodiment are necessary for the present disclosure. Hereinafter, the same or similar elements are denoted by the same or similar reference signs, and the description thereof may be omitted or simplified.

### Information Processing System

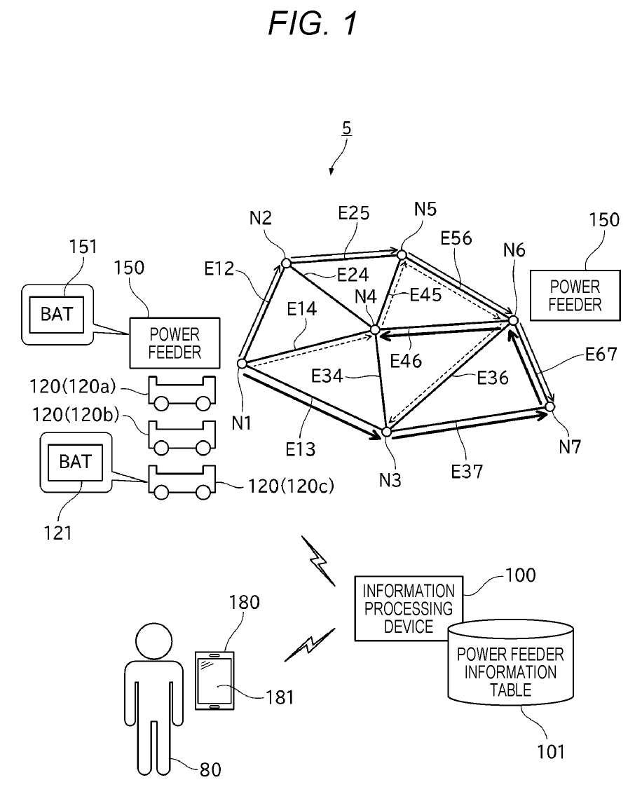

FIG. 1 illustrates an information processing system 5 according to an embodiment of the present disclosure.

As illustrated in FIG. 1, the information processing system 5 of the present embodiment includes an information processing device 100, a plurality of work machines 120 including a work machine 120a, a work machine 120b, and a work machine 120c, a plurality of power feeders 150, and a user terminal 180 used by a user 80. The user 80 is, for example, a worker working at a construction site to be described later.

The user terminal 180 is, for example, a computer that is communicably connected to the information processing device 100 through a communication network implemented by a mobile communication standard (3G, 4G, 5G, 6G, or the like), a wireless LAN, Wi-Fi (registered trademark), the Internet, or the like, and includes a display unit 181 capable of displaying various types of information.

The user terminal 180 includes, for example, an operation input unit implemented by a touch panel, a mouse, a keyboard, or the like, and is configured to be able to receive an operation input by the user 80 via the operation input unit.

More specifically, the user terminal 180 may be a smartphone, a tablet terminal, a notebook computer, a laptop computer, or the like in which an application for displaying a display screen DS to be described later on the display unit 181 is installed. The user terminal 180 may be a non-portable electronic device, and may be, for example, a desktop personal computer in which an application for displaying the display screen DS on the display unit 181 is installed. The display unit 181 of the user terminal 180 may be a liquid crystal display, an organic electro-luminescence (EL) display, or the like. The user terminal 180 is an example of a terminal device.

The information processing device 100 is a computer capable of communicating with the user terminal 180, the work machine 120, and the power feeder 150 through the above-described communication network or the like, and is, for example, a server provided in a data center or the like. At least a part of the communication network connecting the user terminal 180, the work machine 120, or the power feeder 150 to the information processing device 100 may be implemented by a communication cable.

The work machine 120 is a movable body that includes a power storage unit 121 that stores power and is movable using the power of the power storage unit 121. The power storage unit 121 can be implemented by a lithium ion secondary battery, a nickel-hydrogen rechargeable battery, or the like. The work machine 120 is a device that performs predetermined work, and can be, for example, an unmanned vehicle that autonomously travels. As an example, the work machine 120 can be a vehicle for transporting a load.

In the present embodiment, the work machine 120 is operated at a construction site, loads a load such as a material used at the construction site at a predetermined loading place, and travels to a transport destination of the load by autonomous traveling. After unloading the load at the transport destination, the work machine 120 travels to the next loading place of the load by autonomous traveling.

In the present embodiment, a travel route of the work machine 120 is determined by a plurality of nodes each indicating a specific point (in other words, a place) and edges connecting the nodes. Each of the edges is, for example, a straight line connecting nodes. However, the edge is not limited thereto, and the edge may be a curve connecting nodes.

More specifically, as illustrated in FIG. 1, the nodes in the present embodiment include a node N1, a node N2, a node N3, a node N4, a node N5, a node N6, and a node N7.

The edges in the present embodiment include an edge E12 connecting the node N1 and the node N2, an edge E13 connecting the node N1 and the node N3, an edge E14 connecting the node N1 and the node N4, an edge E24 connecting the node N2 and the node N4, an edge E25 connecting the node N2 and the node N5, an edge E34 connecting the node N3 and the node N4, an edge E36 connecting the node N3 and the node N6, an edge E37 connecting the node N3 and the node N7, an edge E45 connecting the node N4 and the node N5, an edge E46 connecting the node N4 and the node N6, an edge E56 connecting the node N5 and the node N6, and an edge E67 connecting the node N6 and the node N7.

The information processing device 100 in the present embodiment can determine an operation plan of the work machine 120. As an example, the information processing device 100 determines the operation plan of the work machine 120 based on a construction plan indicating a construction site, a scheduled construction period, a weight and size of a load transported by the work machine 120, and the like. The operation plan includes, for example, a time when each work machine 120 departs from each node and a time when each work machine 120 arrives at each node on a certain work day.

For example, as indicated by a thin solid arrow in FIG. 1, the work machine 120a departs from the node N1, and then travels along a route that passes through the node N2, the node N5, and the node N6 and reaches the node N7 by moving along the edge E12, the edge E25, the edge E56, and the edge E67 in this order.

In addition, as indicated by a dashed arrow in FIG. 1, the work machine 120b departs from the node N1, and then moves along a route that passes through the node N4, the node N5, and the node N6 and reaches the node N3 by moving along the edge E14, the edge E45, the edge E56, and the edge E36 in this order.

Further, as indicated by a thick solid arrow in FIG. 1, the work machine 120c departs from the node N1, and then moves along a route that passes through the node N3, the node N7, and the node N6 and reaches the node N4 by moving along the edge E13, the edge E37, the edge E67, and the edge E36 in this order.

During the stop time from when the work machine 120 arrives at a certain node until the work machine 120 departs from the node, the work machine 120 may be fed with power by the power feeder 150 installed at the node. Similarly, the power feeder 150 installed at a certain node may be fed with power by another power feeder 150 installed at the node. In other words, each node may be a power feeding point where power is fed by the power feeder 150.

The work machine 120 transmits, for example, work machine information on the work machine 120 to the information processing device 100 at a predetermined cycle. Accordingly, the information processing device 100 can acquire the work machine information on each work machine 120. The work machine information may include, for example, identification information for identifying the work machine 120 and information indicating a current point where the work machine 120 is located.

As an example, the work machine 120 includes a global navigation satellite system (GNSS) receiver, and determines the current point of the work machine 120 based on a signal received from a GNSS satellite by the GNSS receiver. Further, the work machine 120 may determine or complement the current position of the work machine 120 by an inertial navigation system (INS) using detection results of various sensors provided in the work machine 120.

The work machine information may include information indicating the power stored in the power storage unit 121 of the work machine 120. The information indicating the power stored in the power storage unit 121 of the work machine 120 may be information indicating a state of charge (SOC) of the power storage unit 121.

The power feeder 150 is a device capable of supplying power to a power feeding target electrically connected to the power feeder 150. The power feeder 150 includes, for example, a power storage unit 151 that stores power, and supplies the power stored in the power storage unit 151 to a power feeding target. In this case, the power storage unit 151 can be implemented by a lithium ion secondary battery, a nickel-hydrogen rechargeable battery, or the like, similarly to the power storage unit 121.

As an example, the power feeder 150 may be a portable power source including the power storage unit 151. As another example, the power feeder 150 may be a solar power source including a solar panel and the power storage unit 151 capable of storing power generated by the solar panel. As still another example, the power feeder 150 may be a power source (hereinafter, also referred to as a "system power source") that supplies power supplied through a commercial power distribution network owned by a power company to a power feeding target.

In the present embodiment, the information processing system 5 may include a plurality of types of power feeders 150 such as a portable power source, a solar power source, and a system power source. For example, the power feeder 150 as a solar power source or a system power source is fixed at a predetermined point (for example, a node), whereas the power feeder 150 (that is, the portable power feeder 150) as a portable power source can be carried by the user 80 and installed at any point. In addition, the power feeder 150 as a portable power source may be transported by the work machine 120 or the like to any point (for example, a power feeding point) selected by the information processing device 100 based on, for example, a power demand amount to be described later.

An example of the power feeding target of the power feeder 150 is the work machine 120. Another example of the power feeding target of the power feeder 150 is another power feeder 150. That is, one power feeder 150 may feed power to another power feeder 150 as a power feeding target. In this way, the power stored in the power storage unit 151 of one power feeder 150 can charge the power storage unit 151 of another power feeder 150. In other words, it is possible to additionally charge another power feeder 150 with the power of one power feeder 150. Then, the work machine 120 and the like can be charged with the power of another power feeder 150 additionally charged.

In addition, for example, the power feeder 150 transmits power feeder information on the power feeder 150 to the information processing device 100 at a predetermined cycle. Accordingly, the information processing device 100 can acquire the power feeder information on each power feeder 150. The power feeder information may include, for example, identification information for identifying the power feeder 150 and information indicating a current point where the power feeder 150 is located.

As an example, the power feeder 150 includes a GNSS receiver, and determines a current point of the power feeder 150 based on a signal received from a GNSS satellite by the GNSS receiver. The power feeder 150 may determine or complement the current position of the power feeder 150 by an INS using detection results of various sensors provided in the power feeder 150.

The power feeder information may include information indicating the power stored in the power storage unit 151 of the power feeder 150. The information indicating the power stored in the power storage unit 151 of the power feeder 150 may be information indicating the SOC of the power storage unit 151.

Further, the power feeder information may include information indicating a status of the power feeder 150. The status of the power feeder 150 may include, for example, whether the power feeder 150 is connected to a power feeding target, whether power is fed to the power feeding target, and the like.

The information processing device 100 controls the overall information processing of the information processing system 5. The information processing performed by the information processing device 100 may include information collection and analysis processing for ascertaining the overall state of the information processing system 5. The information collection and analysis processing for ascertaining the overall state of the information processing system 5 may include, for example, processing of receiving work machine information from each work machine 120, processing of receiving power feeder information from each power feeder 150, and the like.

The information processing performed by the information processing device 100 may include the above-described processing of determining the operation plan of the work machine 120. Further, the information processing performed by the information processing device 100 may include processing of supporting creation of a charging plan for efficiently charging the work machine 120 and/or the power feeder 150 including the power storage unit 151 (hereinafter, also referred to as "charging plan support processing").

As an example, the charging plan support processing may include processing of transmitting, to the user terminal 180, information necessary for the user terminal 180 to display predetermined information on the display unit 181. In the charging plan support processing, the information that the information processing device 100 can transmit to the user terminal 180 may include information on the power feeder 150.

Here, the information on the power feeder 150 is generated, for example, based on the power feeder information received by the information processing device 100 from each power feeder 150. The information on the power feeder 150 may include, for example, identification information for identifying each power feeder 150, information indicating the current point of each power feeder 150, information indicating the SOC of each power feeder 150 (in other words, the power storage unit 151), and information indicating the status of each power feeder 150.

In the present embodiment, the information processing device 100 includes a power feeder information table 101. The information processing device 100 updates the power feeder information table 101 based on the power feeder information received from the power feeder 150, and transmits the information on the power feeder 150 to the user terminal 180 based on the information stored in the power feeder information table 101. Accordingly, the user terminal 180 can display a display screen DS or the like to be described later. Since the power feeder information table 101 will be described later, a detailed description thereof will be omitted here.

In the charging plan support processing, the information that the information processing device 100 can transmit to the user terminal 180 may include information on the work machine 120. Here, the information on the work machine 120 is generated based on the work machine information received by the information processing device 100 from each work machine 120. The information on the work machine 120 may include, for example, identification information for identifying each work machine 120, information indicating the current point of each work machine 120, and information indicating the SOC of each work machine 120 (in other words, the power storage unit 121).

In the charging plan support processing, the information that the information processing device 100 can transmit to the user terminal 180 may include information indicating the operation plan of the work machine 120, information indicating the travel route of the work machine 120, and the like. Here, the information indicating the operation plan of the work machine 120 can be, for example, information indicating a time when each work machine 120 departs from each node and a time when each work machine 120 arrives at each node on a certain work day. In addition, the information indicating the operation plan of the work machine 120 may include information indicating a stop time during which each work machine 120 is stopped at each node (in other words, a time from arrival at each node to departure from each node). Further, the information indicating the operation plan of the work machine 120 may include information indicating another parameter (for example, a power demand amount and/or a power feeding point to be described later) derived based on the stop time during which each work machine 120 is stopped at each node. The information indicating the travel route of the work machine 120 can be, for example, information indicating each node and edge.

### Power Feeder Information Table

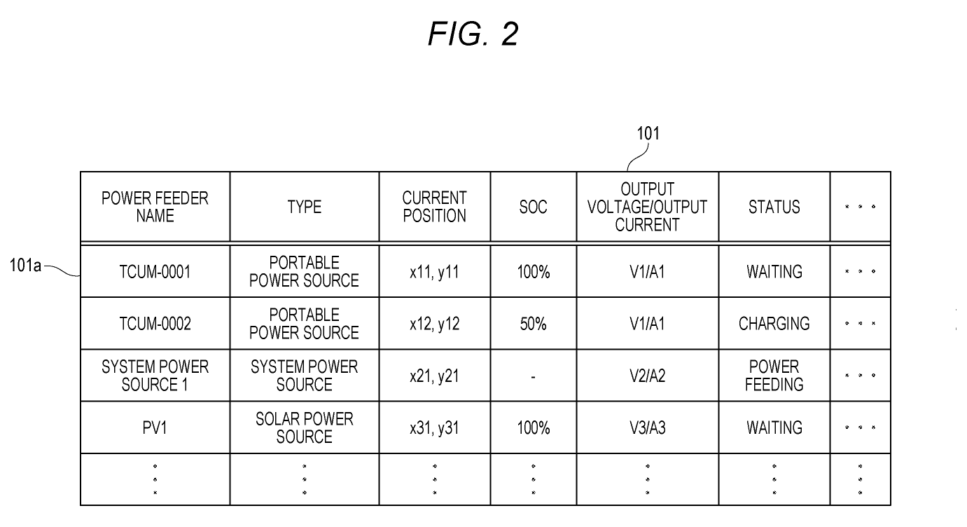

FIG. 2 illustrates an example of the power feeder information table 101. The power feeder information table 101 is stored in, for example, a storage unit included in the information processing device 100. The storage unit can be implemented by, for example, a non-transitory storage medium such as a hard disk or a flash memory.

As illustrated in FIG. 2, the power feeder information table 101 stores information indicating a type, a current position, an SOC of the power storage unit 151, an output (specifically, an output voltage/output current) during power feeding, a status, and the like for the power feeder 150 in association with a power feeder name which is an example of the identification information of the power feeder 150.

As an example, a record 101a of the power feeder information table 101 illustrated in FIG. 2 indicates that for the power feeder 150 with the power feeder name "TCUM-0001", the type is the "portable power source", the current position is "x11, y11", the SOC is "100%", the output voltage is "V1", the output current is "A1", and the status is "waiting (in other words, neither connection to the power feeding target nor power feeding to the power feeding target is performed)".

For example, in the power feeder information table 101, the information indicating the power feeder name, the type, and the output during power feeding for each power feeder 150 is set by, for example, the user 80. The information processing device 100 can update, based on the power feeder information received from the power feeder 150, the information indicating the current position, the SOC, the status, and the like corresponding to the power feeder 150 in the power feeder information table 101.

In the power feeder information table 101, the information indicating the current position of the power feeder 150 whose type is "system power source" or "solar power source" may be set by the user 80. In this case, for example, the user 80 may set information indicating a point where the power feeder 150 whose type is "system power source" or "solar power source" is installed as the information indicating the current position of the power feeder 150.

### Display Screen Displayed by User Terminal

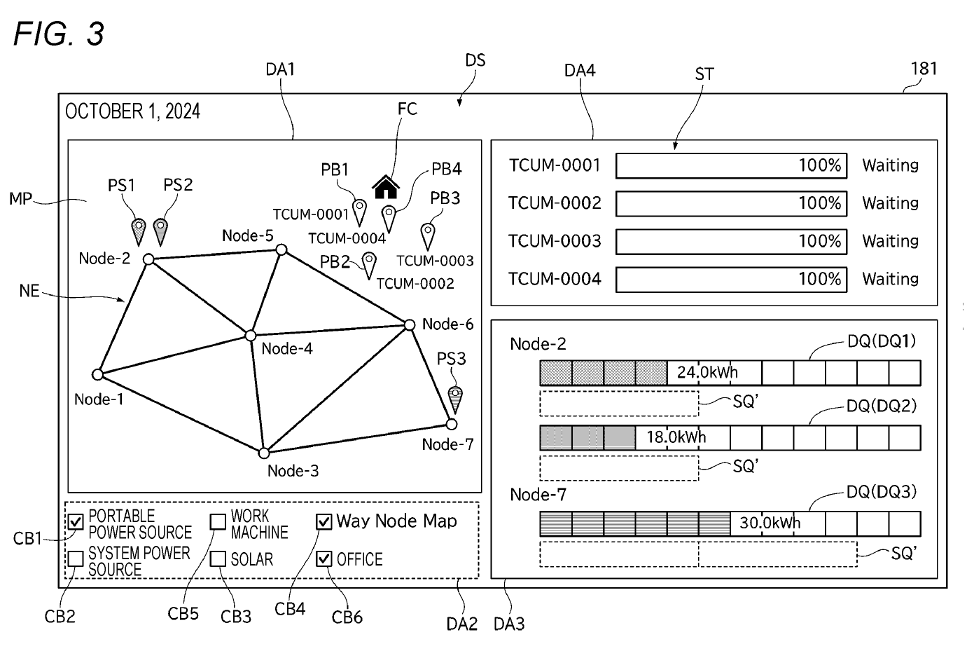

The user terminal 180 can display a predetermined display screen on the display unit 181 based on the information received from the information processing device 100. Hereinafter, display screens that can be displayed by the user terminal 180 will be described in detail with reference to FIGS. 3 to 10.

As illustrated in FIG. 3 and the like, the display screen DS displayed on the display unit 181 by the user terminal 180 is provided with, for example, a map display area DA1 in which a map MP is displayed, and a check box display area DA2 in which check boxes for selecting information displayed on the display screen DS (hereinafter, also simply referred to as "check boxes") is displayed.

The map MP displayed in the map display area DA1 can be, for example, a map representing a terrain of a predetermined range including a construction site where the work machine 120 is operated. The map MP may be a map of a predetermined range centered on any point designated by the user 80. The user terminal 180 can display the map MP based on, for example, map information received from the information processing device 100 or map information stored in the user terminal 180 itself. The user terminal 180 may display the map MP based on map information received from a map information distribution server different from the information processing device 100.

The check boxes displayed in the check box display area DA2 include, for example, a check box for selecting the type of the power feeder 150 to be displayed. In the present embodiment, as the check box for selecting the type of the power feeder 150 to be displayed, a check box CB1 corresponding to the type "portable power source", a check box CB2 corresponding to the type "system power source", and a check box CB3 corresponding to the type "solar power source" are provided.

For example, as illustrated in FIG. 3, it is assumed that the user 80 checks the check box CB1 corresponding to the "portable power source". In this case, the user terminal 180 refers to the information on the power feeder 150 whose type is the "portable power source" among the information received from the information processing device 100, and displays a portable power source icon PB at a location on the map MP corresponding to the current position of each power feeder 150 whose type is the "portable power source".

In the example illustrated in FIG. 3, as the portable power source icon PB, a portable power source icon PB1 corresponding to the power feeder 150 with the power feeder name "TCUM-0001", a portable power source icon PB2 corresponding to the power feeder 150 with the power feeder name "TCUM-0002", a portable power source icon PB3 corresponding to the power feeder 150 with the power feeder name "TCUM-0003", and a portable power source icon PB4 corresponding to the power feeder 150 with the power feeder name "TCUM-0004" are displayed.

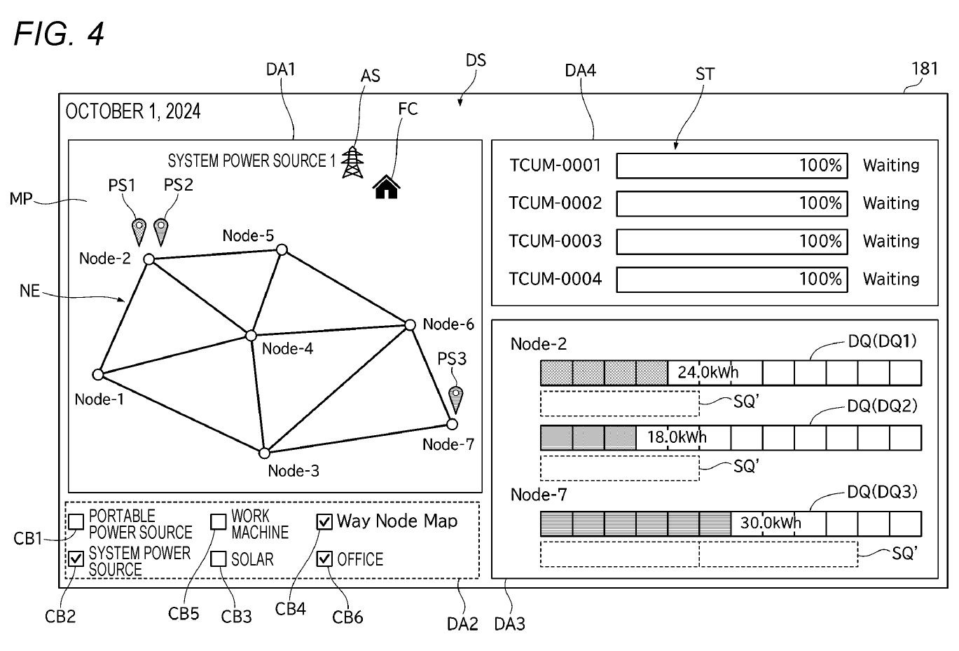

As illustrated in FIG. 4, it is assumed that the user 80 checks the check box CB2 corresponding to the "system power source". In this case, the user terminal 180 refers to the information on the power feeder 150 whose type is the "system power source" among the information received from the information processing device 100, and displays a system power source icon AS at a location on the map MP corresponding to the current position of each power feeder 150 whose type is the "system power source". In the example illustrated in FIG. 4, the system power source icon AS corresponding to the power feeder 150 with the power feeder name "system power source 1" is displayed.

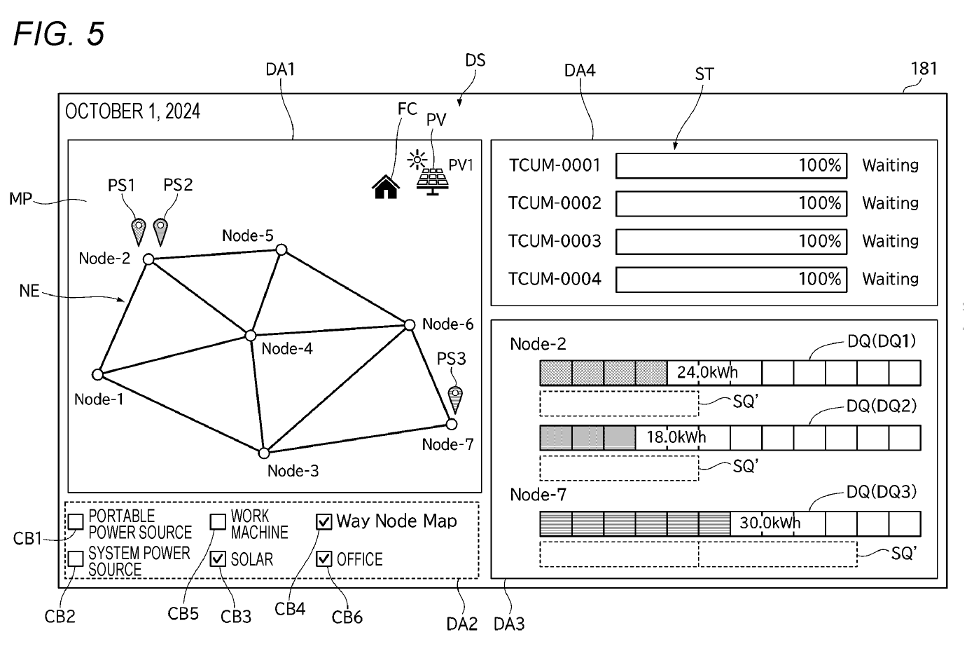

As illustrated in FIG. 5, it is assumed that the user 80 checks the check box CB3 corresponding to the "solar power source". In this case, the user terminal 180 refers to the information on the power feeder 150 whose type is the "solar power source" among the information received from the information processing device 100, and displays a solar power source icon PV at a location on the map MP corresponding to the current position of each power feeder 150 whose type is the "solar power source". In the example illustrated in FIG. 5, the solar power source icon PV corresponding to the power feeder 150 with the power feeder name "PV1" is displayed.

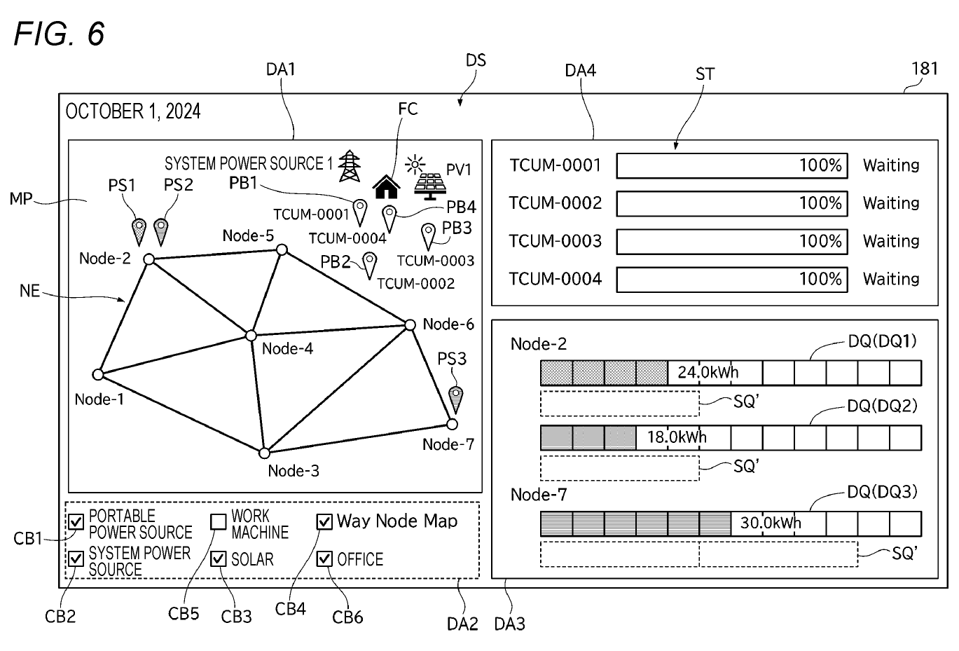

As illustrated in FIG. 6, it is assumed that the user 80 checks each of the check boxes CB1 to CB3. In this case, the user terminal 180 may display an icon corresponding to the type of the power feeder 150 at a location on the map MP corresponding to the current position of each power feeder 150 whose type is the "portable power source", the "system power source", or the "solar power source".

In this way, the user terminal 180 displays the display screen DS that can switch and display the power feeder 150 by type on the map MP. Accordingly, the user terminal 180 can display the display screen DS that allows the user 80 to easily ascertain where the desired type of power feeder 150 is located. Therefore, the convenience of the user 80 can be improved.

More specifically, the user terminal 180 can display the display screen DS on which the power feeder 150 of the type selected by the user 80 (for example, an icon corresponding to the power feeder 150 of the type selected by the user 80) among a plurality of types of power feeders 150 is displayed on the map MP. Accordingly, the user terminal 180 can show the user 80 where the desired type of power feeder 150 is located via the display screen DS. Therefore, the convenience of the user 80 can be improved.

In addition, the user terminal 180 can display the display screen DS on which the power feeders 150 of types other than the type selected by the user 80 are not displayed. Accordingly, the user terminal 180 can prevent the display screen DS from becoming too full of information for the user 80, and can show the user 80 where the desired type of power feeder 150 is located in an easy-to-understand manner via the display screen DS. Therefore, the convenience of the user 80 can be improved.

As described above, the power feeder 150 may include a portable power source (that is, the portable power feeder 150). The position of the power feeder 150, which is a portable power source, can change with time. In this regard, according to the present embodiment, even when the position of the power feeder 150, which is a portable power source, has changed, it is possible to show the position of the power feeder 150 to the user 80 who wants to know the position of the power feeder 150, which is a portable power source, via the display screen DS. Therefore, the convenience of the user 80 can be improved. Further, if status information ST to be described later is also displayed on the display screen DS, the user 80 can easily ascertain the SOC, the status, and the like of each of the power feeders 150 including the power feeder 150, which is a portable power source, from the display screen DS, and thus the convenience of the user 80 is improved.

The check boxes displayed in the check box display area DA2 may include a check box CB4 for switching display/non-display of the travel route of the work machine 120.

In this case, as illustrated in FIG. 3, when the user 80 checks the check box CB4, the user terminal 180 may display a node-edge image NE indicating each node and edge on the map MP as the travel route of the work machine 120 based on the information indicating the travel route of the work machine 120 received from the information processing device 100.

In this way, the user terminal 180 can display the display screen DS capable of displaying the travel route of the work machine 120 on the map MP. Accordingly, the user terminal 180 can show the travel route of the work machine 120 to the user 80 via the display screen DS. Therefore, the convenience of the user 80 can be improved.

The check boxes displayed in the check box display area DA2 may include a check box CB5 for switching display/non-display of the current position of the work machine 120.

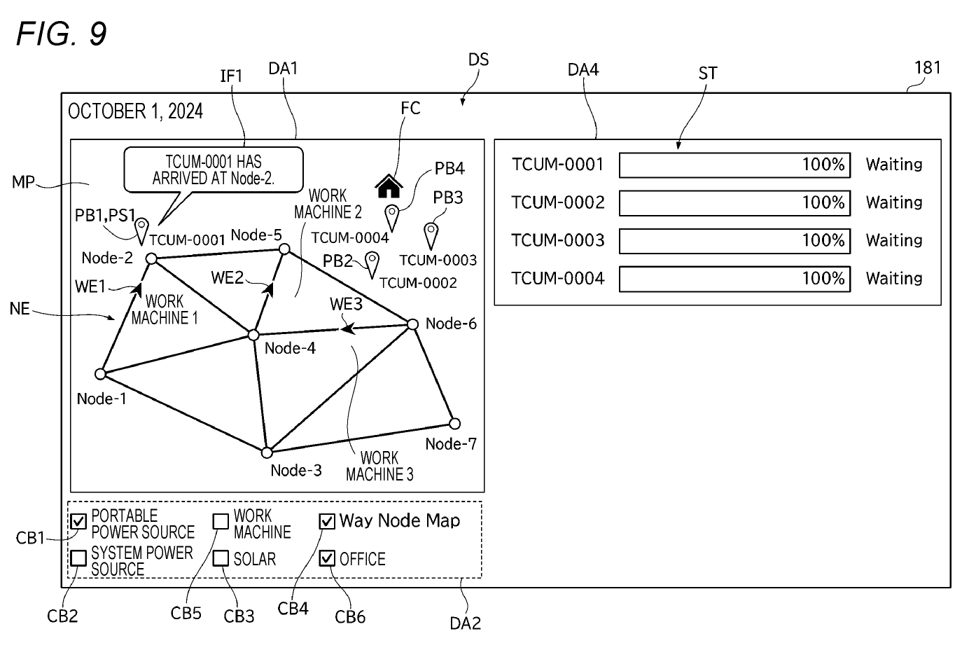

In this case, as illustrated in FIG. 9, when the user 80 checks the check box CB5, the user terminal 180 may display a work machine icon WE at a location on the map MP corresponding to the current position of each work machine 120 with reference to the information on the work machine 120 among the information received from the information processing device 100.

In the example illustrated in FIG. 9, as the work machine icon WE, a work machine icon WE1 corresponding to the work machine 120 with the work machine name "work machine 1", a work machine icon WE2 corresponding to the work machine 120 with the work machine name "work machine 2", and a work machine icon WE3 corresponding to the work machine 120 with the work machine name "work machine 3" are displayed. The work machine icon WE may further indicate a traveling direction of the work machine 120, and may include, for example, an image that imitates an arrow indicating the traveling direction of the corresponding work machine 120.

In this way, the user terminal 180 can display the display screen DS on which each work machine 120 (for example, the work machine icon WE corresponding to each work machine 120) is displayed on the map MP. Accordingly, the user terminal 180 can show the user 80 where each work machine 120 is located via the display screen DS. Therefore, the convenience of the user 80 can be improved.

The check boxes displayed in the check box display area DA2 may include a check box CB6 for switching display/non-display of an office used by the user 80 or the like at the construction site.

In this case, as illustrated in FIG. 3, when the user 80 checks the check box CB6, the user terminal 180 may display an office icon FC at a location on the map MP corresponding to an office location. The information indicating the office location necessary for displaying the office icon FC may be transmitted from the information processing device 100 to the user terminal 180, or may be input to the user terminal 180 by the user 80.

Further, the user terminal 180 may display, on the display screen DS, information indicating an installation place where the power feeder 150 (for example, a portable power source) should be installed, in other words, a power feeding point where power feeding by the power feeder 150 is necessary, based on the information received from the information processing device 100.

In the present embodiment, the user terminal 180 displays a power feeding point icon PS on the map MP as information indicating the power feeding point. The power feeding point is, for example, a node where the power demand amount is larger than a predetermined value (for example, 0), and can be derived based on the operation plan of the work machine 120. The power demand amount at each node can be derived based on, for example, the stop time of the work machine 120 at the node, the SOC of the work machine 120 stopped at the node, the SOC of the power feeder 150 (for example, a portable power source) installed at the node, and the like.

The power feeding point may simply be a node where any of the work machines 120 stops for a certain period of time or more, or may be a node where the work machine 120 with an SOC less than a predetermined value stops for a certain period of time or more.

In addition, when there is a node where the power demand amount is equal to or greater than a threshold value, in other words, there is a node where the power demand amount may not be satisfied by one power feeder 150 (for example, a portable power source), two or more power feeding points may be set for one node.

As another example, when there is a node where power is fed to a plurality of work machines 120 or power feeders 150 at the same time, in other words, there is a node where one power feeder 150 (for example, a portable power source) may have insufficient output (for example, insufficient output current) during power feeding, two or more power feeding points may be set for one node.

In the example illustrated in FIG. 3, the node N2 and the node N7 are set as the power feeding points. Therefore, the user terminal 180 displays, as the power feeding point icon PS, a power feeding point icon PS1 and a power feeding point icon PS2 at a location on the map MP corresponding to the node N2, and a power feeding point icon PS3 at a position on the map MP corresponding to the node N7. Note that the reason why two power feeding point icons, namely, the power feeding point icon PS1 and the power feeding point icon PS2, are displayed for the node N2 is that two power feeding points are set for the node N2.

In this way, the user terminal 180 can display the display screen DS on which each power feeding point (for example, the power feeding point icon PS corresponding to each power feeding point) is displayed on the map MP. Accordingly, the user terminal 180 can show the user 80 a power feeding point where the power feeder 150 (for example, a portable power source) should be installed via the display screen DS. Therefore, the creation of the charging plan by the user 80 can be supported, and the convenience of the user 80 can be improved.

In addition, the user terminal 180 may display demand amount information DQ, which is information indicating a power demand amount at the power feeding point, on the display screen DS. As illustrated in FIG. 3, in the present embodiment, the display screen DS is further provided with a demand and supply information display area DA3 in which the demand amount information DQ is displayed.

In the example illustrated in FIG. 3, demand amount information DQ1 indicating the power demand amount at the power feeding point corresponding to the power feeding point icon PS1 of the node N2, demand amount information DQ2 indicating the power demand amount at the power feeding point corresponding to the power feeding point icon PS2 of the node N2, and demand amount information DQ3 indicating the power demand amount at the power feeding point corresponding to the power feeding point icon PS3 of the node N7 are displayed as the demand amount information DQ.

In this way, the user terminal 180 can display the demand amount information DQ indicating the power demand amount at the power feeding point on the display screen DS. Accordingly, the user terminal 180 can show the power demand amount at the power feeding point to the user 80 via the display screen DS. Therefore, the creation of the charging plan by the user 80 can be supported, and the convenience of the user 80 can be improved.

The demand amount information DQ may be configured by, for example, a graphic with an area corresponding to a magnitude of the power demand amount. As an example, the demand amount information DQ1 illustrated in FIG. 3 is configured as an image imitating a gauge indicating the power demand amount at the power feeding point corresponding to the power feeding point icon PS1 of the node N2. In addition, the demand amount information DQ2 illustrated in FIG. 3 is configured as an image imitating a gauge indicating the power demand amount at the power feeding point corresponding to the power feeding point icon PS2 of the node N2. The demand amount information DQ3 illustrated in FIG. 3 is configured as an image imitating a gauge indicating the power demand amount at the power feeding point corresponding to the power feeding point icon PS3 of the node N7.

In this way, the user terminal 180 can display the demand amount information DQ configured by a graphic with an area corresponding to a magnitude of the power demand amount. Accordingly, the user terminal 180 can intuitively show the power demand amount at the power feeding point to the user 80 via the display screen DS in an easy-to-understand manner, and the convenience of the user 80 is improved.

As illustrated in FIG. 3, the demand amount information DQ may include characters indicating a value of the power demand amount. By displaying such demand amount information DQ, it is possible to explicitly show the power demand amount at the power feeding point to the user 80, and the convenience of the user 80 is improved.

When there is the demand amount information DQ corresponding to each of the plurality of power feeding points, such as the demand amount information DQ1 to DQ3 illustrated in FIG. 3, the user terminal 180 preferably displays the demand amount information DQ in different colors. In this way, the demand amount information DQ corresponding to each power feeding point is distinguished by the display color, and thus it is possible to show the power demand amount at each power feeding point to the user 80 in an easy-to-understand manner, and the convenience of the user 80 is improved.

As an example, when there are a plurality of power feeding points, the user terminal 180 displays the power feeding point icons PS corresponding to the respective power feeding points in different colors. Then, the user terminal 180 displays the power feeding point icon PS corresponding to one power feeding point and the demand amount information DQ indicating the power demand amount at the power feeding point using the same display color. In this way, it is possible to show the power demand amount at which power feeding point the demand amount information DQ indicates to the user 80 in an easy-to-understand manner by the display colors of the power feeding point icon PS and the demand amount information DQ, and the convenience of the user 80 is improved.

Further, the user terminal 180 may display supply amount information SQ indicating a suppliable power amount from the power feeder 150 on the display screen DS. Similarly to the demand amount information DQ, when a plurality of pieces of supply amount information SQ are displayed, the user terminal 180 may display the respective pieces of supply amount information SQ in different colors. In this way, it is possible to distinguish each piece of the supply amount information SQ by the display color and show the suppliable power amount indicated by each piece of the supply amount information SQ to the user 80 in an easy-to-understand manner, and the convenience of the user 80 is improved.

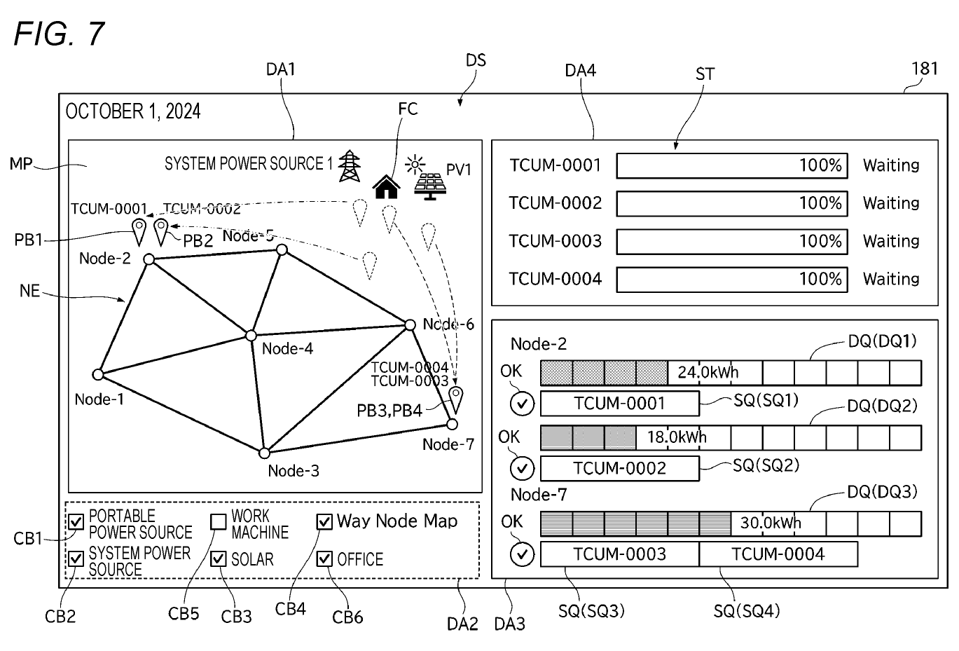

For example, as indicated by an alternated long and short dash arrow in FIG. 7, it is assumed that, on the display screen DS illustrated in FIG. 6, an operation of dragging and dropping the portable power source icon PB1 corresponding to the power feeder 150 with the power feeder name "TCUM-0001" onto the power feeding point icon PS1 is performed on the user terminal 180, so that the power feeder 150 with the power feeder name "TCUM-0001" is set as the power feeder 150 scheduled to be installed at the power feeding point corresponding to the power feeding point icon PS1.

In this way, when the power feeder 150 with the power feeder name "TCUM-0001" is set as the power feeder 150 scheduled to be installed at the power feeding point corresponding to the power feeding point icon PS1, as illustrated in FIG. 7, the user terminal 180 displays, as the supply amount information SQ, supply amount information SQ1 indicating a suppliable power amount from the power feeder 150 with the power feeder name "TCUM-0001" below the demand amount information DQ1 indicating the power demand amount at the power feeding point corresponding to the power feeding point icon PS1 in the demand and supply information display area DA3. Here, the supply amount information SQ1 is configured as, for example, a graphic with an area corresponding to a magnitude of the suppliable power amount from the power feeder 150 with the power feeder name "TCUM-0001". Accordingly, it is possible to show the magnitude of the suppliable power amount to the user 80 in an intuitively easy-to-understand manner, and the convenience of the user 80 is improved.

In addition, in this case, the user terminal 180 compares the power demand amount at the power feeding point corresponding to the power feeding point icon PS1 with the suppliable power amount from the power feeder 150 with the power feeder name "TCUM-0001" scheduled to be installed at the power feeding point. When the suppliable power amount from the power feeder 150 with the power feeder name "TCUM-0001" is equal to or larger than the power demand amount at the power feeding point corresponding to the power feeding point icon PS1, the user terminal 180 displays a demand fulfillment icon OK as a determination result of whether the suppliable power amount satisfies the power demand amount.

Here, the demand fulfillment icon OK is information indicating that the suppliable power amount satisfies the power demand amount, and is configured by, for example, a graphic with a predetermined shape (in the present embodiment, a graphic in which a check mark is placed in ○). In addition, the demand fulfillment icon OK may include characters (for example, "OK") or a symbol indicating the determination result instead of the graphic or together with the graphic. In this way, by displaying the determination result of whether the suppliable power amount satisfies the power demand amount using an object including a graphic, a character, or a symbol, it is possible to show the determination result to the user 80 in an intuitively easy-to-understand manner, and the convenience of the user 80 is improved.

In this case, as illustrated in FIG. 7, the user terminal 180 preferably displays the demand fulfillment icon OK beside the supply amount information SQ1. In this way, it is possible to show the user 80 in an easy-to-understand manner that the suppliable power amount from the power feeder 150 with the power feeder name "TCUM-0001" scheduled to be installed at the power feeding point corresponding to the power feeding point icon PS1 satisfies the power demand amount at the power feeding point.

In addition, similarly to the above, as indicated by an alternated long and two short dashes arrow in FIG. 7, it is assumed that an operation of dragging and dropping the portable power source icon PB2 corresponding to the power feeder 150 with the power feeder name "TCUM-0002" onto the power feeding point icon PS2 is performed on the user terminal 180, so that the power feeder 150 with the power feeder name "TCUM-0002" is set as the power feeder 150 scheduled to be installed at the power feeding point corresponding to the power feeding point icon PS2.

In this way, when the power feeder 150 with the power feeder name "TCUM-0002" is set as the power feeder 150 scheduled to be installed at the power feeding point corresponding to the power feeding point icon PS2, as illustrated in FIG. 7, the user terminal 180 may display, as the supply amount information SQ, supply amount information SQ2 indicating a suppliable power amount from the power feeder 150 with the power feeder name "TCUM-0002" below the demand amount information DQ2 indicating the power demand amount at the power feeding point corresponding to the power feeding point icon PS2 in the demand and supply information display area DA3.

In addition, in this case, the user terminal 180 compares the power demand amount at the power feeding point corresponding to the power feeding point icon PS2 with the suppliable power amount from the power feeder 150 with the power feeder name "TCUM-0002" scheduled to be installed at the power feeding point. When the suppliable power amount from the power feeder 150 with the power feeder name "TCUM-0002" is equal to or larger than the power demand amount at the power feeding point corresponding to the power feeding point icon PS2, the user terminal 180 displays the demand fulfillment icon OK as the determination result of whether the suppliable power amount satisfies the power demand amount.

In the same manner as described above, as indicated by dashed arrows in FIG. 7, it is assumed that the power feeders 150 with the power feeder names "TCUM-0003" and "TCUM-0004" are set as the power feeders 150 scheduled to be installed at the power feeding point corresponding to the power feeding point icon PS3 of the node N7.

In this way, when the power feeders 150 of "TCUM-0003" and "TCUM-0004" are set as the power feeders 150 scheduled to be installed at the power feeding point corresponding to the power feeding point icon PS3 of the node N7, the user terminal 180 may display, as the supply amount information SQ, supply amount information SQ3 indicating the suppliable power amount from the power feeder 150 with the power feeder name "TCUM-0003" and supply amount information SQ4 indicating the suppliable power amount from the power feeder 150 with the power feeder name "TCUM-0003" below the demand amount information DQ3 indicating the power demand amount at the power feeding point corresponding to the power feeding point icon PS3 in the demand and supply information display area DA3.

In such a case, the user terminal 180 compares the power demand amount at the power feeding point corresponding to the power feeding point icon PS3 with a sum of suppliable power amounts from the power feeders 150 with the power feeder names "TCUM-0003" and "TCUM-0004" scheduled to be installed at the power feeding point. When the sum of the suppliable power amounts from the power feeders 150 with the power feeder names "TCUM-0003" and "TCUM-0004" is equal to or larger than the power demand amount at the power feeding point corresponding to the power feeding point icon PS3, the user terminal 180 displays the demand fulfillment icon OK as the determination result of whether the suppliable power amount satisfies the power demand amount. Accordingly, it is possible to show the user 80 whether the sum of the suppliable power amounts from the plurality of power feeders 150 scheduled to be installed at the power feeding point corresponding to the power feeding point icon PS3 is sufficient for the power demand amount, and the convenience of the user 80 is improved.

That is, when there are a plurality of power feeders 150 scheduled to be installed at one power feeding point, the user terminal 180 displays a determination result of whether the sum of the suppliable power amounts from the plurality of power feeders 150 satisfies the power demand amount at the one power feeding point, so that it is possible to show the user 80 whether the sum of the suppliable power amounts from the plurality of power feeders 150 is sufficient for the power demand amount at the power feeding point where the plurality of power feeders 150 are scheduled to be installed.

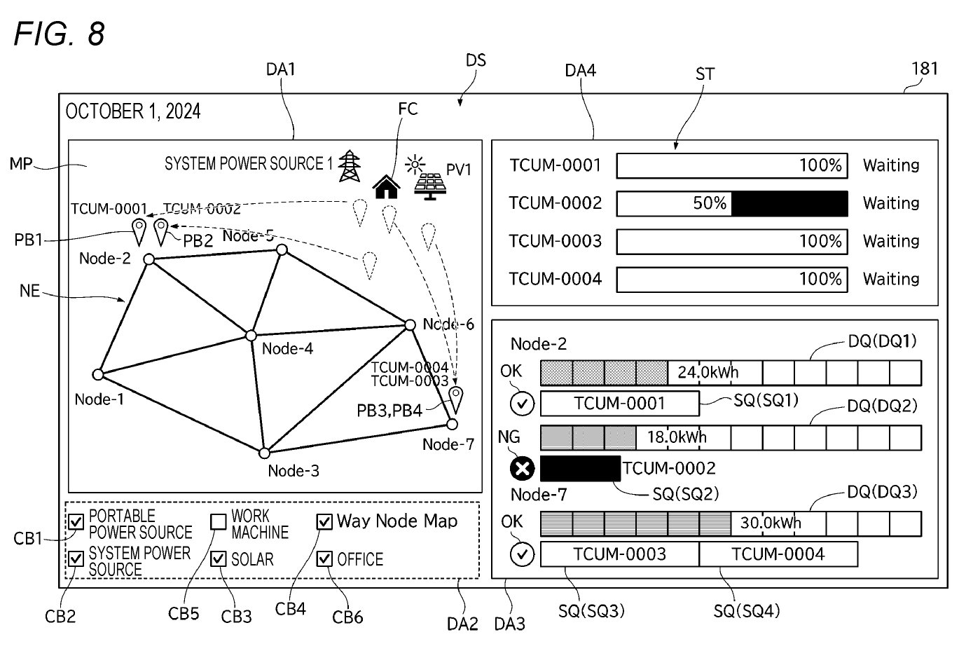

In the example illustrated in FIG. 8, since the SOC of the power feeder 150 with the power feeder name "TCUM-0002" is lower than that in the example illustrated in FIG. 7, the user terminal 180 determines that the suppliable power amount from the power feeder 150 with the power feeder name "TCUM-0002" is less than the power demand amount at the power feeding point corresponding to the power feeding point icon PS2. In such a case, for example, the user terminal 180 displays a demand unfulfillment icon NG beside the supply amount information SQ2. Accordingly, when the power feeder 150 with the power feeder name "TCUM-0002" is installed at the power feeding point corresponding to the power feeding point icon PS2, it is possible to show the user 80 that the power demand amount at the power feeding point is not satisfied.

Here, the demand unfulfillment icon NG is information indicating that the suppliable power amount does not satisfy the power demand amount, and is configured by, for example, a graphic with a shape different from that of the demand fulfillment icon OK (in the present embodiment, a graphic in which x is placed in ○). In this way, since the demand fulfillment icon OK, which is an object displayed when it is determined that the suppliable power amount satisfies the power demand amount, and the demand unfulfillment icon NG, which is an object displayed when it is determined that the suppliable power amount does not satisfy the power demand amount, are configured by graphics with different shapes, the user 80 can distinguish between the demand fulfillment icon OK and the demand unfulfillment icon NG by the shapes. Accordingly, it is possible to show the determination result of whether the suppliable power amount satisfies the power demand amount to the user 80 in an easy-to-understand manner, and the convenience of the user 80 is improved.

In addition, the demand unfulfillment icon NG may include characters (for example, "NG") or a symbol indicating the determination result instead of the graphic or together with the graphic. In this way, it is possible to explicitly show the user 80 the determination result of whether the suppliable power amount satisfies the power demand amount by the characters or the symbol included in the demand unfulfillment icon NG, and the convenience of the user 80 is improved.

The demand fulfillment icon OK and the demand unfulfillment icon NG are preferably displayed in different colors. In this way, the user 80 can easily distinguish between the demand fulfillment icon OK and the demand unfulfillment icon NG not only by the shapes thereof but also by the display colors thereof. Accordingly, it is possible to show the determination result of whether the suppliable power amount satisfies the power demand amount to the user 80 in an easy-to-understand manner, and the convenience of the user 80 is improved.

Further, the user terminal 180 may display the supply amount information SQ displayed beside the demand fulfillment icon OK in the same display color as the demand fulfillment icon OK, and may display the supply amount information SQ displayed beside the demand unfulfillment icon NG in the same display color as the demand unfulfillment icon NG. In other words, the user terminal 180 may display, in the same display color as the demand fulfillment icon OK, the supply amount information SQ indicating the suppliable power amount from the power feeder 150 scheduled to be installed at the power feeding point where the suppliable power amount is determined to satisfy the power demand amount, and may display, in the same display color as the demand unfulfillment icon NG, the supply amount information SQ indicating the suppliable power amount from the power feeder 150 scheduled to be installed at the power feeding point where the suppliable power amount is determined not to satisfy the power demand amount. In this way, it is possible to show the user 80 whether the suppliable power amount is sufficient for the power demand amount not only by the display colors of the demand fulfillment icon OK and the demand unfulfillment icon NG but also by the display color of the supply amount information SQ, and the convenience of the user 80 is improved.

In this way, the user terminal 180 displays, on the display screen DS, the demand fulfillment icon OK or the demand unfulfillment icon NG as the determination result of whether the suppliable power amount from the power feeder 150 satisfies the power demand amount from the work machine 120 or the like based on the information received from the information processing device 100. Accordingly, it is possible to show the user 80 whether the suppliable power amount on a power feeding side is sufficient for the power demand amount on a power receiving side. Accordingly, the user can easily ascertain whether the suppliable power amount satisfies the power demand amount, and the convenience of the user 80 is improved.

Further, as illustrated in FIG. 7 and the like, the user terminal 180 displays, on the display screen DS, the demand fulfillment icon OK or the demand unfulfillment icon NG together with the demand amount information DQ indicating the power demand amount and the supply amount information SQ indicating the suppliable power amount. Accordingly, it is possible to show the user 80 not only whether the suppliable power amount is sufficient for the power demand amount but also a difference between the suppliable power amount and the power demand amount. Therefore, the user can also ascertain the difference between the suppliable power amount and the power demand amount, and the convenience of the user 80 is improved.

The user terminal 180 may allow the user 80 to select display/non-display of the supply amount information SQ. As an example, when an operation of hiding the supply amount information SQ is performed, the user terminal 180 may display the supply amount information SQ in a collapsed form to make the supply amount information SQ invisible. When an operation of displaying the supply amount information SQ is performed, the user terminal 180 may display the supply amount information SQ in an expanded form to make the supply amount information SQ visible.

Further, the user terminal 180 may display, on the display screen DS, guide information SQ' for showing how many power feeders 150 (for example, portable power sources) are required to satisfy the power demand amount at the power feeding point. Accordingly, the user terminal 180 can show how many power feeders 150 (for example, portable power sources) are required to satisfy the power demand amount at the power feeding point, and the convenience of the user 80 can be improved.

For example, as illustrated in FIG. 6, when the power feeder 150 scheduled to be installed at the power feeding point corresponding to the power feeding point icon PS1 is not set, the user terminal 180 may display guide information SQ' indicating the suppliable power amount of one power feeder 150 which is the portable power source below the demand amount information DQ1 indicating the power demand amount at the power feeding point corresponding to the power feeding point icon PS1 in the demand and supply information display area DA3.

The guide information SQ' is configured as, for example, a graphic with an area corresponding to a magnitude of the suppliable power amount of one power feeder 150 which is a portable power source. In the present embodiment, the guide information SQ' is configured as one or two or more rectangles, and one rectangle indicates the suppliable power amount of one power feeder 150 which is a portable power source.

The user terminal 180 may allow the user 80 to select display/non-display of the guide information SQ'. As an example, when an operation of hiding the guide information SQ' is performed, the user terminal 180 may display the guide information SQ' in a collapsed form to make the guide information SQ' invisible. When an operation of displaying the guide information SQ' is performed, the user terminal 180 may display the guide information SQ' in an expanded form to make the guide information SQ' visible.

Furthermore, the user terminal 180 may display status information ST, which is information indicating the SOC and status of each power feeder 150, on the display screen DS. As illustrated in FIG. 3 and the like, in the present embodiment, a status information display area DA4 is further provided on the display screen DS. The user terminal 180 displays the status information ST in the status information display area DA4.

The status information ST may include, for example, a graphic with an area corresponding to the SOC of each power feeder 150 including the power storage unit 151 (that is, the power stored in the power storage unit 151). As an example, in the example illustrated in FIG. 3 and the like, the status information ST includes an image imitating a gauge indicating the SOC of each power feeder 150. As illustrated in FIG. 3 and the like, the status information ST may include, for example, characters (for example, characters "Waiting" illustrated in FIG. 3) or an image indicating the status of each power feeder 150.

By displaying such status information ST, the user terminal 180 can show the SOC and status of each power feeder 150 to the user 80, and the convenience of the user 80 can be further improved.

Further, as illustrated in FIG. 9, when the power feeder 150 (for example, a portable power source) has arrived at a power feeding point corresponding to the power feeder 150, the user terminal 180 may display, on the display screen DS, power feeder arrival information IF1 indicating that the power feeder 150 has arrived at the power feeding point.

In the example illustrated in FIG. 9, the node N2 is set as the power feeding point of the power feeder 150 with the power feeder name "TCUM-0001". For example, it is determined that the power feeder 150 with the power feeder name "TCUM-0001" has arrived at the node N2 based on the information on the power feeder 150 received from the information processing device 100, and thus the user terminal 180 displays a message "TCUM-0001 has arrived at Node-2" on the display screen DS (specifically, on the map MP of the map display area DA1) as the power feeder arrival information IF1.

In this way, when the power feeder 150, which is a portable power source, has arrived at the power feeding point corresponding to the power feeder 150, the user terminal 180 displays the display screen DS including the power feeder arrival information IF1 indicating that the power feeder 150 has arrived at the power feeding point, and thus can show the user 80 that the power feeder 150 has arrived at the corresponding power feeding point.

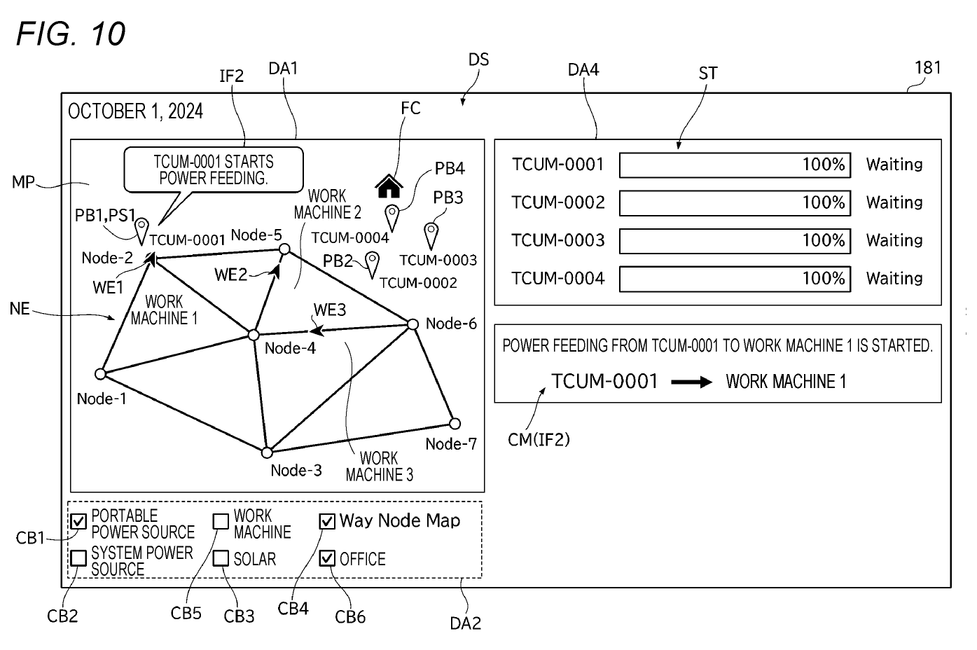

As illustrated in FIG. 10, when power feeding from one power feeder 150 of the power feeders 150 to a power feeding target (for example, the work machine 120 or another power feeder 150) is started, the user terminal 180 may display, on the display screen DS, power feeding start information IF2 indicating that power feeding from one power feeder 150 is started.

In the example illustrated in FIG. 10, since it is determined that the power feeding from the power feeder 150 with the power feeder name "TCUM-0001" to the power feeding target is started based on the information on the power feeder 150 received from the information processing device 100, the user terminal 180 displays a message "TCUM-0001 has started power feeding" on the display screen DS (specifically, on the map MP of the map display area DA1) as the power feeding start information IF2. Further, as illustrated in FIG. 10, at this time, the user terminal 180 may display the message as the power feeding start information IF2 in association with the portable power source icon PB of the power feeder 150 that has started the power feeding.

Further, as illustrated in FIG. 10, the user terminal 180 may display, as the power feeding start information IF2, character information CM including information indicating a power feeding target, such as "TCUM-0001 starts power feeding. TCUM-0001 → Work machine 1".

In this way, by displaying the power feeding start information IF2, the user terminal 180 can show the user 80 that the power feeding from the power feeder 150 to the power feeding target has started via the display screen DS.

### Example of Processing Executed by User Terminal

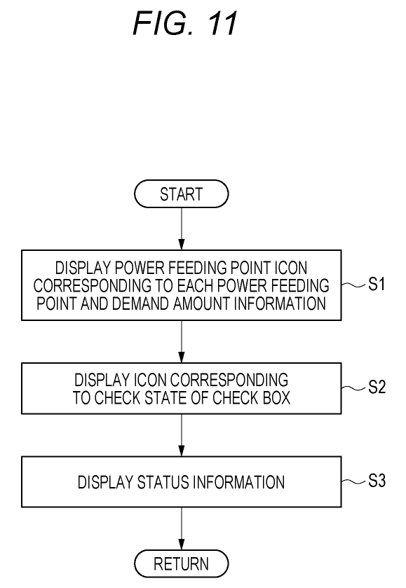

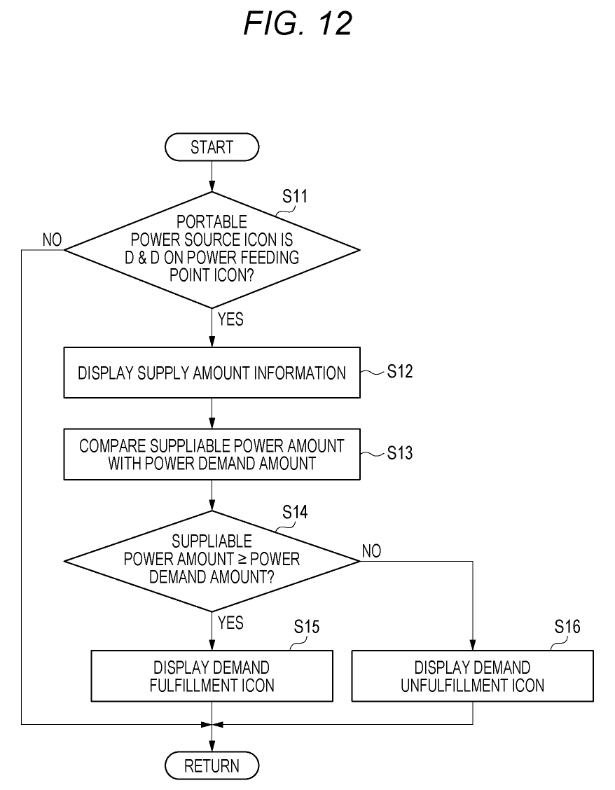

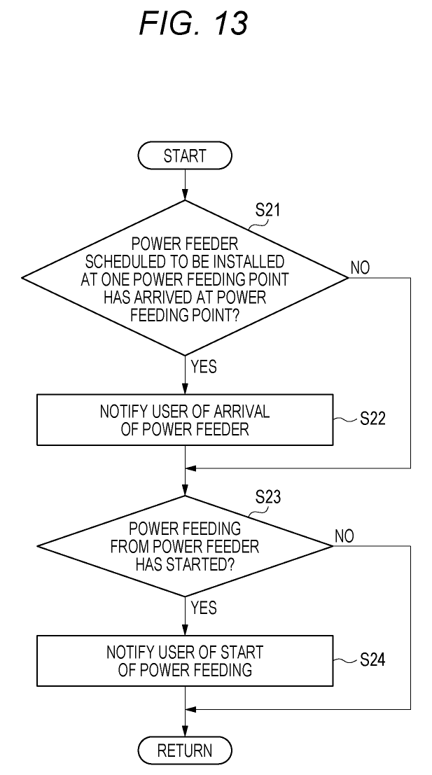

Next, an example of processing executed by the user terminal 180 will be described. The user terminal 180 can execute, for example, each of first display processing illustrated in FIG. 11, second display processing illustrated in FIG. 12, and third display processing illustrated in FIG. 13 at a predetermined cycle.

### First Display Processing

FIG. 11 is a flowchart illustrating an example of the first display processing. As illustrated in FIG. 11, in the first display processing, the user terminal 180 displays the power feeding point icon PS corresponding to each power feeding point and the demand amount information DQ indicating the power demand amount at each power feeding point on the display screen DS of the display unit 181 based on the information received from the information processing device 100 (step S1).

Next, the user terminal 180 displays, on the display screen DS, icons corresponding to check states of check boxes (for example, check boxes CB1 to CB6) for selecting information displayed on the display screen DS (step S2). For example, when the check box CB1 is checked, the user terminal 180 may display the portable power source icon PB corresponding to the power feeder 150 whose type is the "portable power source" based on the information on the power feeder 150 received from the information processing device 100 in the processing of step S2.

Next, the user terminal 180 displays the status information ST indicating the SOC and the like of each power feeder 150 on the display screen DS (step S3), and ends the current first display processing. In the processing of step S3, the user terminal 180 may display the status information ST indicating the SOC and the like of all the power feeders 150, or may display the status information ST indicating the SOC and the like of only the power feeder 150 displayed through the processing of step S2.

### Second Display Processing

FIG. 12 is a flowchart illustrating an example of the second display processing. As illustrated in FIG. 12, in the second display processing, the user terminal 180 determines whether any portable power source icon PB is dragged and dropped (illustrated as "D & D") on one power feeding point icon PS displayed on the display screen DS (step S11).

If it is determined that the portable power source icon PB is not dragged and dropped on the one power feeding point icon PS (step S11: NO), the user terminal 180 ends the current second display processing as it is. On the other hand, if it is determined that the portable power source icon PB is dragged and dropped on the one power feeding point icon PS (step S11: YES), the user terminal 180 displays, on the display screen DS, the supply amount information SQ indicating the suppliable power amount from the power feeder 150 corresponding to the portable power source icon PB dragged and dropped on the one power feeding point icon PS (step S12).

Then, the user terminal 180 compares the suppliable power amount from the power feeder 150 corresponding to the portable power source icon PB dragged and dropped on the one power feeding point icon PS with the power demand amount at the power feeding point corresponding to the one power feeding point icon PS (step S13), and determines whether the suppliable power amount is equal to or larger than the power demand amount (step S14).

If it is determined that the suppliable power amount is equal to or larger than the power demand amount (step S14: YES), the user terminal 180 displays the demand fulfillment icon OK (step S15), and ends the current second display processing. On the other hand, if it is determined that the suppliable power amount is less than the power demand amount (step S14: NO), the user terminal 180 displays the demand unfulfillment icon NG (step S16) and ends the current second display processing.

### Third Display Processing

FIG. 13 is a flowchart illustrating an example of the third display processing. As illustrated in FIG. 13, in the third display processing, the user terminal 180 determines whether the power feeder 150 scheduled to be installed at one power feeding point (in other words, a node) has arrived at the power feeding point based on the information (for example, the information on the power feeder 150) received from the information processing device 100 (step S21).

If it is determined that the power feeder 150 scheduled to be installed at the one power feeding point has not arrived at the power feeding point (step S21: NO), the user terminal 180 directly proceeds to the processing of step S23. On the other hand, if it is determined that the power feeder 150 scheduled to be installed at the one power feeding point has arrived at the power feeding point (step S21: YES), the user terminal 180 notifies the user 80 that the power feeder 150 scheduled to be installed at the one power feeding point has arrived at the power feeding point by displaying the power feeder arrival information IF1 or the like (step S22), and proceeds to the processing of step S23.

Next, the user terminal 180 determines whether the power feeding from one power feeder 150 to the power feeding target has started based on the information (for example, the information on the power feeder 150) received from the information processing device 100 (step S23).

If it is determined that the power feeding from one power feeder 150 to the power feeding target has not started (step S23: NO), the user terminal 180 ends the current third display processing as it is. On the other hand, if it is determined that the power feeding from one power feeder 150 to the power feeding target has started (step S23: YES), the user terminal 180 notifies the user 80 that the power feeding from one power feeder 150 to the power feeding target has started by displaying the power feeding start information IF2 or the like (step S24), and ends the current third display processing.

As described above, according to the present embodiment, it is possible to perform appropriate display that can improve the convenience of the user 80.

The control method described in the present embodiment can be implemented by a computer executing a program (control program) prepared in advance. The control program is stored in, for example, a computer-readable storage medium and executed by being read from the storage medium. In addition, the control program may be provided in a form stored in a non-volatile (non-transitory) storage medium such as a flash memory, or may be provided via a communication network such as the Internet.

In the present embodiment, the computer that executes the control program is the user terminal 180 (for example, a processor of the user terminal 180), but the present disclosure is not limited thereto, and for example, the computer may be the information processing device 100. That is, at least a part of the processing described as the processing performed by the user terminal 180 in the present embodiment may be performed by the information processing device 100.

More specifically, in this case, for example, the information processing device 100 may generate the display screen DS illustrated in FIGS. 3 to 10 and the like, and transmit information for causing the display unit 181 to display the generated display screen DS to the user terminal 180. Then, the user terminal 180 may display the display screen DS on the display unit 181 based on the information received from the information processing device 100. In this case, the same effects as those of the embodiment described above can also be obtained.

Although each embodiment of the present disclosure has been described, it goes without saying that the present disclosure is not limited to this embodiment. It is apparent to those skilled in the art that various changes or modifications can be conceived within the scope described in the claims, and it is understood that the changes or modifications naturally fall within the technical scope of the present disclosure. In addition, the constituent elements in the embodiment described above may be freely combined without departing from the gist of the disclosure.

For example, the "node" in the embodiment described above is an example of a place where the power feeder 150 should be installed. The place where the power feeder 150 should be installed may not only be a specific point but also a region with an area. For example, the place where the power feeder 150 should be installed may be a rectangular region obtained by dividing a work site in a grid pattern.

In the present description, at least the following matters are described. Although corresponding constituent elements and the like in the embodiment described above are illustrated in parentheses, the present disclosure is not limited thereto.

(1) An information processing system (information processing system 5) including:

an information processing device (information processing device 100);

a terminal device (user terminal 180) communicably connected to the information processing device and including a display unit (display unit 181);

a first device (work machine 120, power feeder 150) including a first power storage unit (power storage units 121 and 151); and

a second device (power feeder 150) including a second power storage unit (power storage unit 151) and configured to supply power stored in the second power storage unit to the first device, in which

the terminal device displays, on the display unit, a determination result (demand fulfillment icon OK, demand unfulfillment icon NG) of whether a suppliable power amount from the second device satisfies a power demand amount from the first device, based on information received from the information processing device.

According to (1), by displaying the determination result of whether the suppliable power amount from the second device on the power feeding side satisfies the power demand amount from the first device on the power receiving side, it is possible to show the user whether the suppliable power amount is sufficient for the power demand amount. Accordingly, the user can easily ascertain whether the suppliable power amount satisfies the power demand amount, and the convenience of the user is improved.

(2) The information processing system according to (1), in which

the terminal device displays the determination result together with demand amount information (demand amount information DQ) indicating the power demand amount and supply amount information (supply amount information SQ) indicating the suppliable power amount.

According to (2), by displaying the determination result of whether the suppliable power amount satisfies the power demand amount together with the demand amount information indicating the power demand amount and the supply amount information indicating the suppliable power amount, it is possible to show the user not only whether the suppliable power amount is sufficient for the power demand amount but also a difference between the suppliable power amount and the power demand amount. Accordingly, the user can also ascertain the difference between the suppliable power amount and the power demand amount, and the convenience of the user is improved.

(3) The information processing system according to (2), in which

the terminal device displays, as the determination result, an object (demand fulfillment icon OK, demand unfulfillment icon NG) corresponding to the determination result, and

the object includes a graphic, a character, or a symbol.

According to (3), by displaying the determination result of whether the suppliable power amount satisfies the power demand amount using an object including a graphic, a character, or a symbol, it is possible to show the determination result to the user in an intuitively easy-to-understand manner, and the convenience of the user is improved.

(4) The information processing system according to (3), in which

an object (demand fulfillment icon OK) displayed when it is determined that the suppliable power amount satisfies the power demand amount and an object (demand unfulfillment icon NG) displayed when it is determined that the suppliable power amount does not satisfy the power demand amount are displayed in different colors.

According to (4), the object displayed when it is determined that the suppliable power amount satisfies the power demand amount and the object displayed when it is determined that the suppliable power amount does not satisfy the power demand amount are displayed in colors different from each other, so that the user can distinguish these objects by the display colors thereof. Accordingly, it is possible to show the determination result of whether the suppliable power amount satisfies the power demand amount to the user in an easy-to-understand manner, and the convenience of the user is improved.

(5) The information processing system according to (2), in which

the terminal device

displays, as the demand amount information, a graphic with an area corresponding to a magnitude of the power demand amount, and

displays, as the supply amount information, a graphic with an area corresponding to a magnitude of the suppliable power amount.

According to (5), by displaying the graphic with the area corresponding to the magnitude of the power demand amount as the demand amount information and displaying the graphic with the area corresponding to the magnitude of the suppliable power amount as the supply amount information, it is possible to show the magnitudes of the power demand amount and the suppliable power amount to the user in an intuitively easy-to-understand manner, and the convenience of the user is improved.

(6) The information processing system according to (2), in which

when a plurality of pieces of the demand amount information (demand amount information DQ1 to DQ3) are displayed, the terminal device displays the respective pieces of the demand amount information in different colors.

According to (6), when a plurality of pieces of demand amount information are displayed, the respective pieces of demand amount information are displayed in different colors, so that the user can distinguish the respective pieces of demand amount information by the display colors thereof. Accordingly, it is possible to show the power demand amount indicated by the respective pieces of demand amount information to the user in an easy-to-understand manner, and the convenience of the user is improved.

(7) The information processing system according to (2), in which

when a plurality of pieces of the supply amount information are displayed, the terminal device displays the respective pieces of the supply amount information in different colors.

Accordingly to (7), when a plurality of pieces of supply amount information are displayed, the respective pieces of supply amount information are displayed in different colors, so that the user can distinguish the respective pieces of supply amount information by the display colors thereof. Accordingly, it is possible to show the suppliable power amount indicated by the respective pieces of supply amount information to the user in an easy-to-understand manner, and the convenience of the user is improved.

(8) The information processing system according to (2), in which

when there is the demand amount information corresponding to each of a plurality of power feeding points, the terminal device displays respective pieces of the demand amount information in different colors.

According to (8), when there is the demand amount information corresponding to each of a plurality of power feeding points, by displaying the respective pieces of demand amount information in different colors, it is possible to show the demand amount information corresponding to each of the power feeding points to the user in an intuitively easy-to-understand manner, and the convenience of the user is improved.

(9) The information processing system according to (1), in which

when there are a plurality of the second devices scheduled to be installed at one power feeding point, the terminal device displays, on the display unit, a determination result of whether a sum of suppliable power amounts from the plurality of second devices satisfies the power demand amount at the one power feeding point.

According to (9), when there are a plurality of second devices scheduled to be installed at one power feeding point, it is possible to display a determination result of whether the sum of the suppliable power amounts from the plurality of second devices satisfies the power demand amount at the power feeding point. Accordingly, it is possible to show the user whether the sum of the suppliable power amounts from the plurality of second devices scheduled to be installed at one power feeding point is sufficient for the power demand amount, and the convenience of the user is improved.

(10) The information processing system according to any one of (1) to (9), in which

the terminal device displays, on the display unit, information (portable power source icons PB1 to PB4) indicating a position of the second device together with the determination result.

According to (10), by displaying the information indicating the position of the second device together with the determination result of whether the suppliable power amount satisfies the power demand amount, it is also possible to show the user the information indicating where the second device is located, and the convenience of the user is improved.

(11) The information processing system according to any one of (1) to (9), in which

the second device includes a portable power feeder.

According to (11), by showing the user whether the suppliable power amount is sufficient for the power demand amount, it is possible to support creation of a plan such as where to install the portable power feeder.

(12) A control method in an information processing system (information processing system 5), the information processing system including:

an information processing device (information processing device 100);

a terminal device (user terminal 180) communicably connected to the information processing device and including a display unit (display unit 181);

a first device (work machine 120, power feeder 150) including a first power storage unit (power storage units 121 and 151); and

a second device (power feeder 150) including a second power storage unit (power storage unit 151) and configured to supply power stored in the second power storage unit to the first device, in which

the terminal device displays, on the display unit, a determination result (demand fulfillment icon OK, demand unfulfillment icon NG) of whether a suppliable power amount from the second device satisfies a power demand amount from the first device, based on information received from the information processing device.

According to (12), by displaying, on the display unit, the determination result of whether the suppliable power amount from the device on the power feeding side satisfies the power demand amount from the device on the power receiving side, it is possible to show the user whether the suppliable power amount is sufficient for the power demand amount. Accordingly, the user can easily ascertain whether the suppliable power amount satisfies the power demand amount, and the convenience of the user is improved.

(13) A control program in an information processing system (information processing system 5), the information processing system including:

an information processing device (information processing device 100);

a terminal device (user terminal 180) communicably connected to the information processing device and including a display unit (display unit 181);

a first device (work machine 120, power feeder 150) including a first power storage unit (power storage units 121 and 151); and

a second device (power feeder 150) including a second power storage unit (power storage unit 151) and configured to supply power stored in the second power storage unit to the first device, in which

the control program causes the terminal device to perform processing of displaying, on the display unit, a determination result (demand fulfillment icon OK, demand unfulfillment icon NG) of whether a suppliable power amount from the second device satisfies a power demand amount from the first device, based on information received from the information processing device.

According to (13), by displaying the determination result of whether the suppliable power amount from the second device on the power feeding side satisfies the power demand amount from the first device on the power receiving side, it is possible to show the user whether the suppliable power amount is sufficient for the power demand amount. Accordingly, the user can easily ascertain whether the suppliable power amount satisfies the power demand amount, and the convenience of the user is improved.

(14) A storage medium storing the control program according to (13).

According to (14), the control program can be executed by a computer.

(15) An information processing device in an information processing system (information processing system 5), the information processing system including:

the information processing device (information processing device 100);

a terminal device (user terminal 180) communicably connected to the information processing device and including a display unit (display unit 181);

a first device (work machine 120, power feeder 150) including a first power storage unit (power storage units 121 and 151); and

a second device (power feeder 150) including a second power storage unit (power storage unit 151) and configured to supply power stored in the second power storage unit to the first device, in which

the information processing device transmits, to the terminal device, information for causing the display unit to display a determination result (demand fulfillment icon OK, demand unfulfillment icon NG) of whether a suppliable power amount from the second device satisfies a power demand amount from the first device.

According to (15), by causing the display unit of the terminal device to display the determination result of whether the suppliable power amount from the device on the power feeding side satisfies the power demand amount from the device on the power receiving side, it is possible to show the user whether the suppliable power amount is sufficient for the power demand amount. Accordingly, the user can easily ascertain whether the suppliable power amount satisfies the power demand amount, and the convenience of the user is improved.

(16) A terminal device in an information processing system (information processing system 5), the information processing system including:

an information processing device (information processing device 100);

the terminal device (user terminal 180) communicably connected to the information processing device and including a display unit (display unit 181);

a first device (work machine 120, power feeder 150) including a first power storage unit (power storage units 121 and 151); and

a second device (power feeder 150) including a second power storage unit (power storage unit 151) and configured to supply power stored in the second power storage unit to the first device, in which

the terminal device receives, from the information processing device, information for causing the display unit to display a determination result (demand fulfillment icon OK, demand unfulfillment icon NG) of whether a suppliable power amount from the second device satisfies a power demand amount from the first device, and displays the determination result based on the information.

According to (16), by displaying, on the display unit, the determination result of whether the suppliable power amount from the device on the power feeding side satisfies the power demand amount from the device on the power receiving side, it is possible to show the user whether the suppliable power amount is sufficient for the power demand amount. Accordingly, the user can easily ascertain whether the suppliable power amount satisfies the power demand amount, and the convenience of the user is improved.

1. An information processing system comprising:
an information processing device;
a terminal device communicably connected to the information processing device and including a display unit;
a first device including a first power storage unit; and
a second device including a second power storage unit and configured to supply power stored in the second power storage unit to the first device, wherein
the terminal device is configured to display, on the display unit, a determination result of whether a suppliable power amount from the second device satisfies a power demand amount from the first device, based on information received from the information processing device.

2. The information processing system according to claim 1, wherein
the terminal device is configured to display the determination result together with demand amount information indicating the power demand amount and supply amount information indicating the suppliable power amount.

3. The information processing system according to claim 2, wherein
the terminal device is configured to display, as the determination result, an object corresponding to the determination result, and
the object includes a graphic, a character, or a symbol.

4. The information processing system according to claim 3, wherein
an object displayed when it is determined that the suppliable power amount satisfies the power demand amount and an object displayed when it is determined that the suppliable power amount does not satisfy the power demand amount are displayed in different colors.

5. The information processing system according to claim 2, wherein the terminal device is configured to:
display, as the demand amount information, a graphic with an area corresponding to a magnitude of the power demand amount; and
display, as the supply amount information, a graphic with an area corresponding to a magnitude of the suppliable power amount.

6. The information processing system according to claim 2, wherein
when a plurality of pieces of the demand amount information are displayed, the terminal device displays the respective pieces of the demand amount information in different colors.

7. The information processing system according to claim 2, wherein
when a plurality of pieces of the supply amount information are displayed, the terminal device displays the respective pieces of the supply amount information in different colors.

8. The information processing system according to claim 2, wherein
when there is the demand amount information corresponding to each of a plurality of power feeding points, the terminal device displays respective pieces of the demand amount information in different colors.

9. The information processing system according to claim 1, wherein
when there are a plurality of the second devices scheduled to be installed at one power feeding point, the terminal device displays, on the display unit, a determination result of whether a sum of suppliable power amounts from the plurality of second devices satisfies the power demand amount at the one power feeding point.

10. The information processing system according to claim 1, wherein
the terminal device displays, on the display unit, information indicating a position of the second device together with the determination result.

11. The information processing system according to claim 1, wherein
the second device includes a portable power feeder.

12. A control method in an information processing system, the information processing system comprising:
an information processing device;
a terminal device communicably connected to the information processing device and including a display unit;
a first device including a first power storage unit; and
a second device including a second power storage unit and configured to supply power stored in the second power storage unit to the first device, wherein
the control method comprises displaying, by the terminal device, a determination result of whether a suppliable power amount from the second device satisfies a power demand amount from the first device on the display unit, based on information received from the information processing device.

13. A non-transitory computer-readable storage medium storing a control program in an information processing system, the information processing system comprising:
an information processing device;
a terminal device communicably connected to the information processing device and including a display unit;
a first device including a first power storage unit; and
a second device including a second power storage unit and configured to supply power stored in the second power storage unit to the first device, wherein
the control program causes the terminal device to perform a process including displaying, on the display unit, a determination result of whether a suppliable power amount from the second device satisfies a power demand amount from the first device, based on information received from the information processing device.

14. An information processing device in an information processing system, the information processing system comprising:
the information processing device;
a terminal device communicably connected to the information processing device and including a display unit;
a first device including a first power storage unit; and
a second device including a second power storage unit and configured to supply power stored in the second power storage unit to the first device, wherein
the information processing device is configured to transmit, to the terminal device, information for causing the display unit to display a determination result of whether a suppliable power amount from the second device satisfies a power demand amount from the first device.
